(19) United States
(12) Patent Application Publication
(10) Pub. No.: US 2001/0045515 A1
(43) Pub. Date: Nov. 29, 2001

(54) ANALYSIS ELECTRON MICROSCOPE

(76) Inventors: YUJI SATO, HITACHINAKA-SHI (JP); SHIGETO ISAKOZAWA, HITACHINAKA-SHI (JP); WATARU SHIMOYAMA, HITACHINAKA-SHI (JP)

Correspondence Address: KENYON & KENYON, 1500 K STREET, N.W., SUITE 700, WASHINGTON, DC, 20005, US

(21) Appl. No.: 09/156,431

(22) Filed: Sep. 18, 1998

(30) Foreign Application Priority Data
Sep. 19, 1997 (JP) 9-254858

(51) Int. Cl. G21K 7/00; G01N 23/00

(52) U.S. Cl. 250/311

(57) ABSTRACT

In order to provide an analysis electron microscope which is capable of effectively performing elementary analysis of plural analysis points of a sample, an electron beam 2 discharged from an electronic source 1 irradiates the sample through a condenser lens aperture 3. The electron beam 2 transmitted through the sample 12 is magnified by an objective lens and a plural focussing lens 18 and forms an electron microscope image of the sample 12 on a fluorescent plate 13. A characteristic X-ray emitted from the sample 12 is detected by the elementary analysis device having the elementary analysis detecting element 16 and an elementary analysis control equipment 17 and is analyzed. The position of the analysis points 1 and 2 of the sample and the spot size of the irradiation electron beam is stored in an electron microscope control equipment 14 beforehand, and when the analysis starts, the stored position and size information begin to be read, the analysis points 1 and 2 and the electron beam size are set automatically based on the information, and the elementary analysis of the analysis points 1 and 2 is thereby performed automatically.

### BACKGROUND OF THE INVENTION

(a) Technical Field to Which the Invention Belongs

The present invention relates to an analysis electron microscope, especially to the analysis electron microscope, which is suitable to elementary-analyze plural analysis points of a sample.

(b) Prior Art

Recently, trials to elementary-analyze a desired part of the sample by using an electron microscope are sometimes performed. Generally the electron microscope of this type is called an analysis electron microscope. The elementary analysis by using the analysis electron microscope is generally performed as follows;

At first, the sample to be analyzed is set in the electron microscope. In order to search for a part of the sample to be analyzed, an irradiation lens current is set up so as to make the size (diameter) of the electron beam for irradiating the sample large. Then the magnification of the electron microscope is set lower, and the sample image is observed with a fluorescent plate. When the part desired for the analysis is not found, the sample is moved with a sample movement means so as to find it.

If the part to be analyzed is found, a total magnification image of the analyzed part is filmed and recorded as an image after having adjusted the magnification of the electron microscope. Next, the irradiation lens current is adjusted to the size of the analyzed part (substantially the same as the size of the electron beam). For example, the size of the electron beam is set up as 1 nm. By varying the irradiation lens current, the size of the electron beam is changed so as to form various circles on the sample, and the setting is easily performed. Moreover, by the adjustment of a deflecting coil current for the electron beam, the electron beam, which irradiates the sample, may be moved to a needed arbitrary direction. Accordingly, the setting of the irradiation of the electron beam towards the arbitrary analysis part of the sample becomes possible by adjusting the current of the irradiation lens and the deflecting coil.

When the sample is irradiated with the electron beam, a specific X-ray corresponding to a construction element is emitted from the irradiated part. Moreover, the electron beam, which is transmitted through the sample, loses energy of the electron beam corresponding to the construction element of the sample. The former method to measure the characteristic X-ray is a kind of an elementary analysis apparatus called an energy disperse X-ray spectroscopy (EDS:Energy Disperse X-ray Spectroscopy), and the latter method to measure the energy of the electron beam is a kind of an elementary analysis apparatus called an electron energy loss spectroscopy (EELS: Electron Energy Loss Spectroscopy) The EDS is easy to execute, but is generally weak in its analysis of light elements. Conversely, the EELS is suitable for light elementary analysis.

An X-ray elementary analysis device will be explained here. When the sample is irradiated with the electron beam, a characteristic X-ray corresponding to the element occurs from the irradiated part, and the X-ray elementary analysis device indicates the dosage of the characteristic X-ray. In this way, it may be known what kind of element is included in the part of the sample irradiated by the electron beam.

When an accelerated electron collides with an atom, some of the electrons arranged in the circumference of the atomic nucleus are moved out. Whereby, the atom changes into an excited state with energy. In the empty place where the electron moves out, an outer electron in a higher energy level falls in, and an X-ray (characteristic X-ray) equivalent to the energy differential is emitted. As this energy level is fixed depending on the element, measuring the energy of the emitted X-ray performs the elementary analysis. The X-ray analysis device has a function to indicate the X-ray spectrum, shown by a horizontal scale of the X-ray energy and a vertical scale of the count number (amount of X-rays).

According to the usual analysis steps, the sample is irradiated with the electron beam by operating the electron microscope, a switch to start the counting of the X-rays by the X-ray analysis device is switched on, and the X-ray is multiplied and measured between only the multiplication time for inputting it into the X-ray analysis device beforehand. In order to store the measured X-ray spectrum as a recording, after having input the name of the X-ray spectrum to store into the X-ray analysis device, the switch to store it is turned on. After a clearing switch is turned on once to erase the display of the X-ray spectrum on a display screen, the next analysis is done.

In this way, the operation of the electron microscope normally are independently performed with an operation unit of the electron microscope, and the operation of the X-ray analysis device is performed with an operation unit of the X-ray analysis device respectively.

For example, an electron microscope having an elementary analysis device is mentioned in Japanese Patent Laid-open No. 1-102839 bulletin in addition to above.

### SUMMARY OF THE INVENTION

Recently, difference of composition at the points which left several nm each other has come to have an important meaning; accordingly, when an elementary analysis is done, the elementary analysis of not only the part which should be analyzed but also the plural peripheral parts needs to be done. However, in such a case, after having respectively set the size of the electron beam by adjusting the irradiation lens current and an irradiation position by the electron beam of the sample, namely an analysis position by adjusting the deflecting coil current, the elementary analysis signal is measured for between 100 to 200 seconds by turning the elementary analysis device lower case, and this operation should be performed repeatedly according to the number of parts to be analyzed.

An object of the present invention is to provide an analysis electron microscope, which is capable to do an elementary analysis of plural analysis point of a sample effectively.

An analysis electron microscope of the present invention comprises a means for generating an electron beam, a means for irradiating a sample with said electron beam, a means for producing an electron microscope image of said sample by magnifying said electron beam transmitted through said sample, and an elementary analysis device for elementary-analyzing an irradiated part of said sample by irradiating it with said electron beam; and said analysis electron microscope is characterized by further comprising a means for storing positional information for plural analysis points of said sample, wherein the reading out of said stored positional information, the setting of positions of said analysis points irradiated by said electron beam on the basis of said positional information read out, and said elementary analysis by said elemental analysis device of said irradiated analysis points are automatically executed with an order determined previously about said plural analysis points.

### BRIEF DESCRIPTION OF THE DRAWINGS

FIG. 1 shows a conception diagram of one embodiment of the analysis electron microscope in the present and shows a state irradiating the sample with the electron beam of a big size.

FIG. 2 shows a conception diagram of one embodiment of the analysis electron microscope in the present invention is shown and shows a state irradiating the sample with the electron beam of a small size.

FIG. 3 shows a conception diagram of one embodiment of the analysis electron microscope in the present invention is shown and shows a state irradiating a part deviated from a center of the sample with a small sized electron beam.

FIG. 4 shows a conception diagram of another embodiment of the analysis electron microscope in the present invention.

FIG. 5 shows a flowchart diagram of an example of the analysis in the present invention.

FIG. 6 shows a drawing of the electron microscope image of the desired analysis region in the present invention.

FIG. 7 shows an explanatory drawing of one analysis type in the present invention.

FIG. 8 shows an explanatory drawing of another analysis type in the present invention.

FIG. 9 shows an explanatory drawing of a third analysis type in the present invention further.

FIG. 10 shows a drawing of a display example of the analysis result in the present invention is shown.

FIG. 11 shows a drawing of an image of the electron beam spot size at the analysis starting in the present invention.

FIG. 12 shows a drawing of an image of the electron beam spot size at the analysis ending in the present invention.

FIG. 13 shows a drawing of an example in which the position of the analysis point and the position data are indicated so as to overlap on the image of the desired analysis region in the present invention.

FIG. 14 shows a drawing of another display example according to the analysis result in the present invention.

FIG. 15 shows a drawing of an another example in which the position of the analysis point and the position data are indicated so as to overlap on the image of the desired analysis region in the present invention.

FIG. 16 shows a drawing of a graph of the content of phosphorus (P) in each analysis point in the present invention.

### DETAILED DESCRIPTION OF THE PREFERRED EMBODIMENT

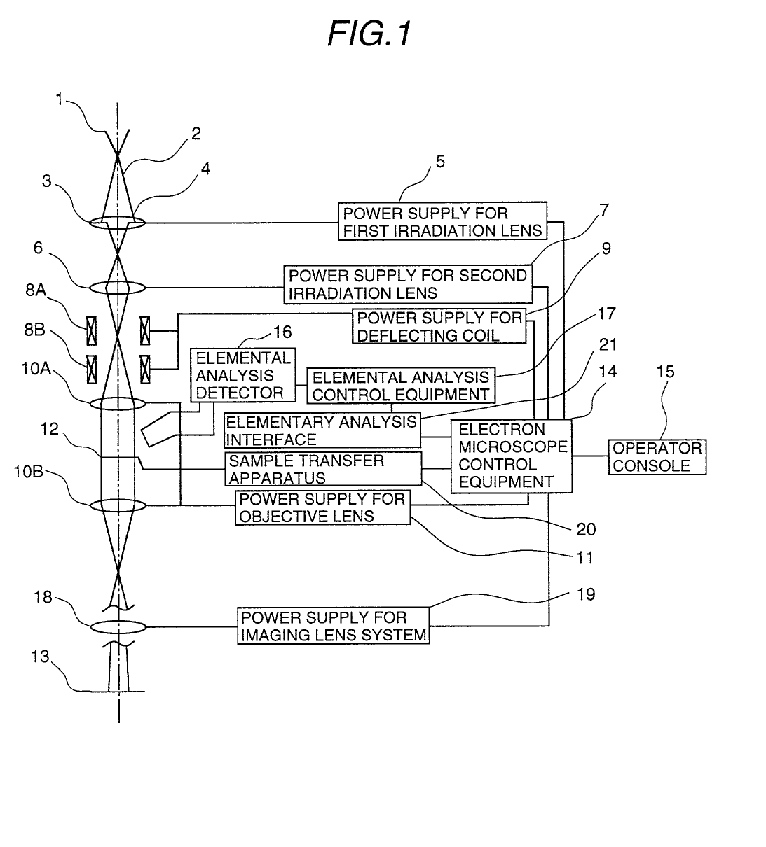

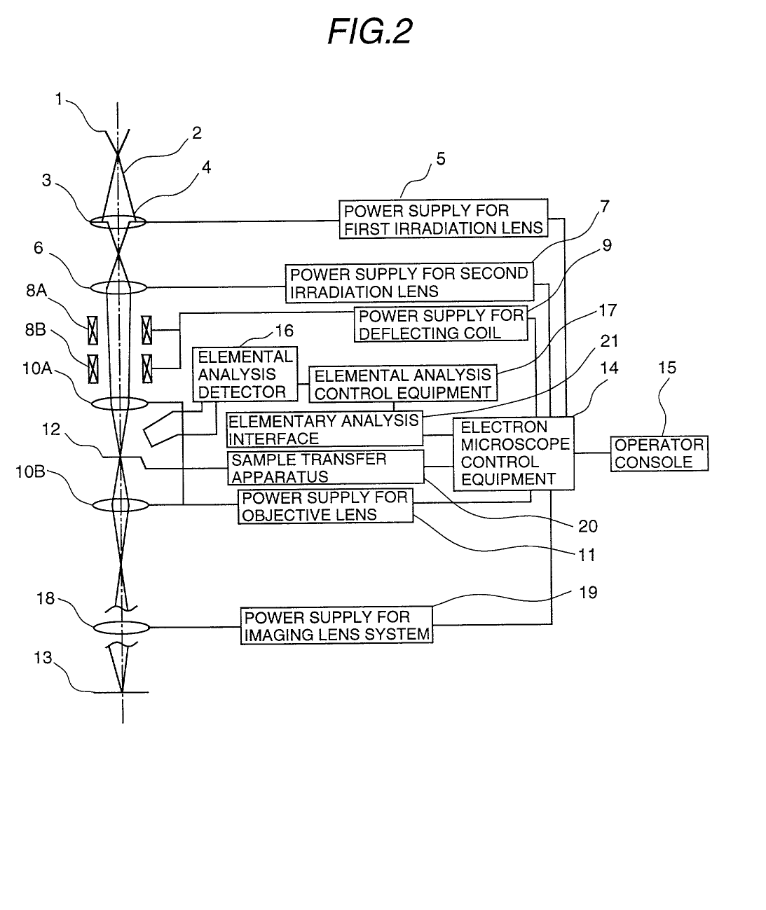

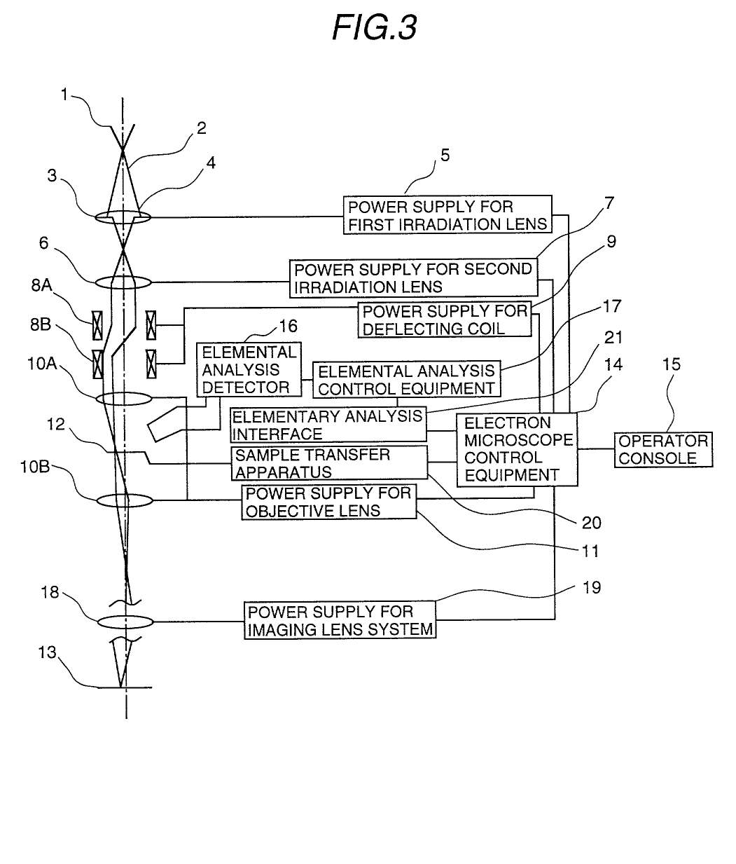

FIGS. 1 to 3 show conceptual diagrams of an embodiment of the analysis electron microscope of the present invention, FIG. 1 shows a state irradiating the sample with an electron beam of a large size (diameter), FIG. 2 shows a state irradiating the sample with an electron beam of a small size, and the FIG. 3 shows a state irradiating a part away from a center of the sample with and electron beam of a small size.

An electron beam 2 discharged from electronic source 1 passes through a condenser lens aperture 3, and irradiates a sample 12. The sample 12 is able to move only an arbitrary distance in an arbitrary direction by mean of a sample transfer device 20 in a flat surface vertical to the electron beam 1. The front magnetic field lens 10a of the first irradiation lens 4, the second irradiation lens 6 and an objective lens work to converge the electron beam 2, and a change in the focus can be made by adjusting an exciting current of the first condenser lens 3 and the second condenser lens 6. Deflecting coil 8a and 8b, which are arranged between the magnetic field lens 10a before the second condenser lens 6 and an objective lens, deflect the electron beam 2 and work to change the irradiation location of the sample 12 by the electron beam 2. The electron beam 2 transmitted rough the sample 12 is magnified by the rear magnetic field lens 10b for the objective lens and plural focusing lens 18, and an electron microscope image of the sample 12 is formed on a fluorescent plate 13 top.

When the sample 12 is emitted with the electron beam 2, a characteristic X-ray occurs from sample 12 corresponding to the element constituting said sample. This characteristic X-ray is detected and analyzed by the elementary analysis device having an elementary analysis detecting element 16 and elementary analysis control equipment 17.

The first irradiation lens 4 is driven and controlled by the first irradiation lens power source 5, the second irradiation lens 6 is driven and controlled by the second irradiation lens power source 7, the deflecting coil 8a and 8b are driven and controlled by the deflecting coil power source 9, the front magnetic field lens 10a and the rear magnetic field lens 10b are driven and controlled by the objective lens power source 11, and the plural focusing lens systems 18 are driven and controlled by plural focusing lens power supply systems 19.

The electron microscope control equipment 14 drives and controls the first irradiation lens power source 5, the second irradiation lens power source 7, the deflecting coil power source 9, the objective lens power source 11, the focusing lens system power source 19, the sample transfer device 20 and the elementary analysis interface 21. Only a pair of the deflecting coils 6a and 6b are illustrated the drawing, however, another pair of deflecting coils are actually arranged further in a vertical direction from it.

The elementary analysis control equipment 17 and the electron microscope control equipment 14 are connected through an elementary analysis interface 21. The interface 21 has an ON/OFF function to control taking in the elementary analysis signal of said elementary analysis device namely the elementary analysis data at least, a function to store the elementary analysis data taken in into the elementary analysis device, a function to clear an image of the elementary analysis data of the elementary analysis device, a function to transmit the identification data of the irradiation position to the elementary analysis device, and a function to receive a message of the content or the number of counts of a specified element from the elementary analysis device in the plural analysis points that received an elementary analysis, with data that can be distinguished by the elementary analysis device.

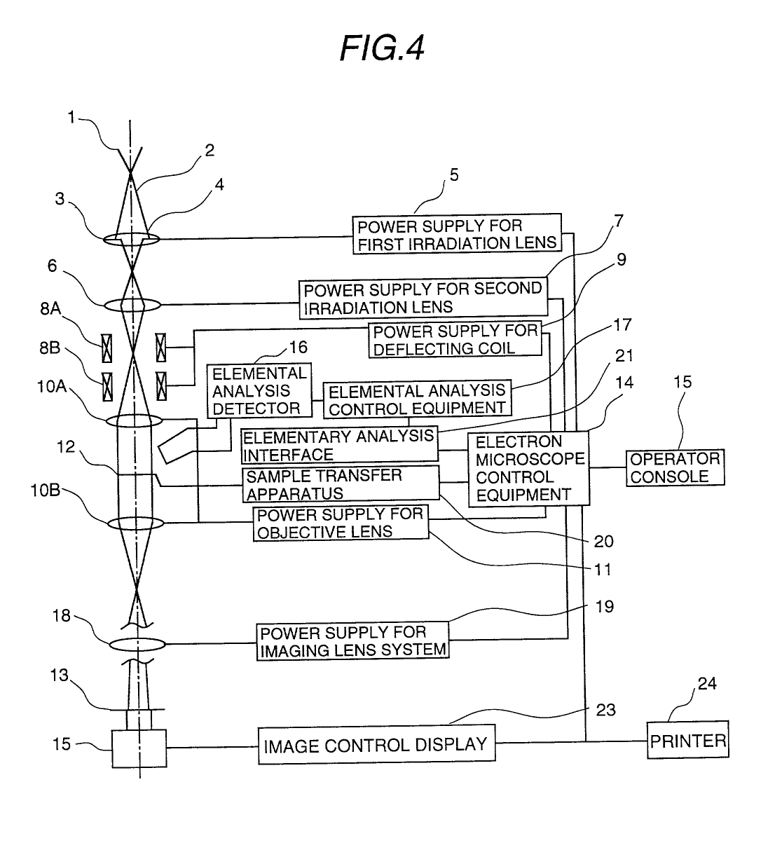

FIG. 4 is a conception diagram of another embodiment of the analysis electron microscope of the present invention. The different points of the FIG. 4 from FIG. 1 are an image pickup device 22 to pick up an electron microscope image formed by the fluorescent plate 13, an image control display device 23 connected with said image pickup device, and a printer 24 connected to said image control display device; and said image control display device 23 and said printer 24 are controlled by the electron microscope control equipment 14.

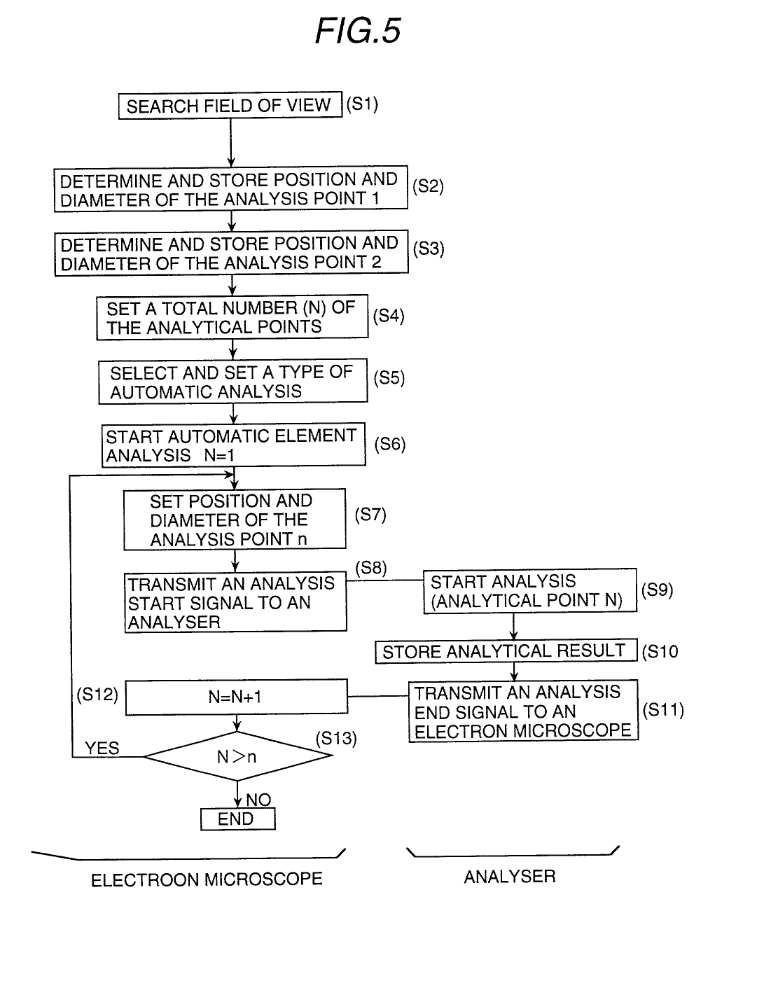

An elementary analysis step in the embodiment shown by FIGS. 1 to 4 will be explained by referring to FIG. 5. Preceding the analysis, the sample 12 that is going to be analyzed is set to a predetermined position on the electron microscope, and the setting of the analysis condition (for example, the amount of time to analyze it, the sample name, the time and date, and the element to be analyzed) is performed.

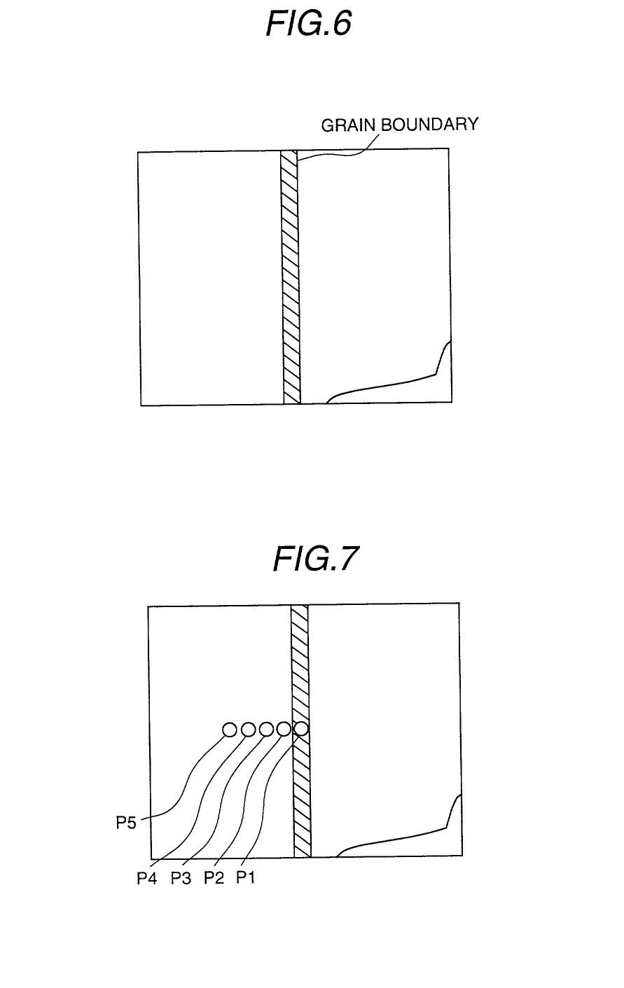

The field of the view is found in step 1 (S1). That is, by operating an operator console 15, the size (diameter) of the electron beam 2 is set up in an appropriate value to find the field of the view (cf. FIG. 1 and FIG. 4). This value is bigger than that in an elementary analysis explained later. The setting of this value is performed by controlling the first irradiation lens power source 5 and the second irradiation lens power source 7 by the electron microscope control equipment 14, and by changing the exciting current of the first irradiation lens 3 and the second irradiation lens 6 driven by those power source. In this state, after searching for the desired part which should be elementary-analyzed by moving the sample transfer device 20, and having found while observing the electron microscope image of the sample 12 on the fluorescent plate 13, the electron microscope image is picked up with the image pickup device 22, is indicated on the image control display means 23, and it is stored. The stored electron microscope image is shown in FIG. 6. In this figure, a vertical stripe in the central part shows that a grain boundary is different depending on its composition, and this grain boundary region indicates the part for performing the elementary analysis. In this case, the grain boundary part becomes a center of the part desired to be analyzed.

In a step 2 (S2), the electron beam 2 is converged to the center of the sample 2 (cf. FIG. 2) so that the spot size (diameter) on the sample 2 becomes 1 nm, for example. The positional information of the sample irradiation point (analysis point l)—determined in this way by the electron beam 2 of the sample 12 and the size information of the irradiation electron beam are stored with the position identification data of the analysis point 1 in the electron microscope control equipment 14. In the same way that the field search is done, setting the size of the electron beam 2 is possible by changing the exciting current of the first irradiation lens 3 and the second irradiation lens 6 driven by the first irradiation lens power source 5 and the second irradiation lens power source 7 controlled by the electron microscope control equipment 14, and the exciting current is can be changed by operating console 15.

In step 3 (S3), the electron beam 2 is deflected by the deflecting coil 8a and 8b so that a point for other analysis (analysis point 2) is irradiated by the electron beam 2, and the positional information of the analysis point 2 determined above and the size information of the electron beam 2 irradiating the analysis point 2 are stored with the position identification data of the analysis point 2 in the electron microscope control equipment 14. The size of the electron beam may be the same as that of the electron beam, which is used when the analysis point 1 is analyzed, or may be different. The quantity of the deflection of the electron beam 2 is determined by the deflecting current to flow through the deflecting coils 8a and 8b, driven by the deflecting coil power source 9 controlled by the electron microscope control equipment 14, and the deflecting current can be changed by the operating console 15. When determining analysis point 2 in addition to the above, in stead of changing the deflecting current of the deflecting coil 8a and 8b, the sample 12 may be moved for the electron beam 2.

In step 4 (S4), the total number N of the analysis points is set and stored in the operating console 15 of the electron microscope. Moreover, the type of the above analysis is set in step 5 (S5) as explained later. Operating the console 15 performs this. In the case that the total number N of the analysis point is previously set as 3 or more, for example 5, the positions of the analysis points 3, 4 and 5 except analysis point 1 and 2, can be calculated (as explained later) by the electron microscope control equipment 14 based on the positional information of the analysis points 1 and 2.

When an analysis starting switch (not shown in the figures) is turned on as n=1 with step 6 (S6), the positional information of analysis point 1 that should be analyzed at first and the size information of the electron beam 2 for analyzing the analysis point 1, will thereby begin to be read as step 7 (step 7), and the setting of the analysis point 1 and the size of the electron beam 2 is performed automatically.

The setting of the analysis point 1 is performed automatically by controlling the sample transfer device 20 or the deflecting coil power source 9 with the electron microscope control equipment 15, and moreover, the setting of the size of the electron beam is performed automatically by controlling the first irradiation lens power source 5 and the second irradiation lens power source 7 with the electron microscope control equipment 15

After the above setting is performed, an analysis start signal is transmitted to the elementary analysis device from the electron microscope control equipment 15 as step 8 (S8), and the analysis device thereby starts the elementary analysis of the analysis point 1 according to the condition set beforehand as step 9 (S9). When the analysis of the analysis point 1 is finished, the analysis device stores the analysis result, and a display screen of the analysis device is cleared as step 10 (S10), and an analysis end signal is transmitted to the microscope control equipment 15 from the analysis device as step 11 (S11).

The electron microscope control equipment 15 adds 1 to the number n (n=n+1) as step 12 (S12), and it furthermore judges whether n<N as step 13 (S13). In this case, when the an answer to the above judgment is YES, the flow chart returns to step 7 (S7) and same steps are repeated in the same way as in the case of the analysis point 1 relating to the analysis point 2 automatically. When the analysis of the analysis point 2 is finished, the elementary analysis of the analysis point 3 is performed, and when the answer to the judgment in the step 13 (S13) is YES for the analysis of the analysis point 3, the flow chart returns to step 7 (S7), and the position of the analysis point 3 is calculated as explained later based on the positional information of the analysis point 1 and 2, and the calculated position is set.

Here, a spot size of the electron beam as in the case of analyzing the analysis point 1 is used with precedence as the spot size of the electron beam.

When the analysis of analysis point 3 is finished, the elementary analysis of the analysis point 4 and 5 are performed in the same way as in the analysis of the analysis point 3, and when the judgment result in step 13 (S13) is NO, the flowchart changes to END.

The positional information calculated for the analysis points 3 to 5 is stored with the position identification information in the electron microscope control equipment 15 beforehand in the same way as the positional information of the analysis points 1 and 2, and the stored positional information may be read so as to be set up when the flow chart returns to step 7 (S7).

Regarding analysis types, there are some analysis type that may be shown by FIGS. 7-9.

FIG. 7 shows a type in which the analysis points 1 to 5 are arranged on a straight line which goes through from the analysis point 1 existing in the grain boundary to the analysis point 2 existing outside of the grain boundary.

The distances of the analysis points 2 and 3, analysis points 3 and 4 and analysis points 4 and 5 are set to respectively be equal to distance L of the analysis points 1 and 2.

In this case, the distance L is obtained based on the positional information of the analysis point 1 and 2 by the electron microscope control equipment 15, and the positions of the analysis points 3 to 5 are calculated based on the distance L.

In this case, the distances of points next to each other among analysis points 1-5 are each L.

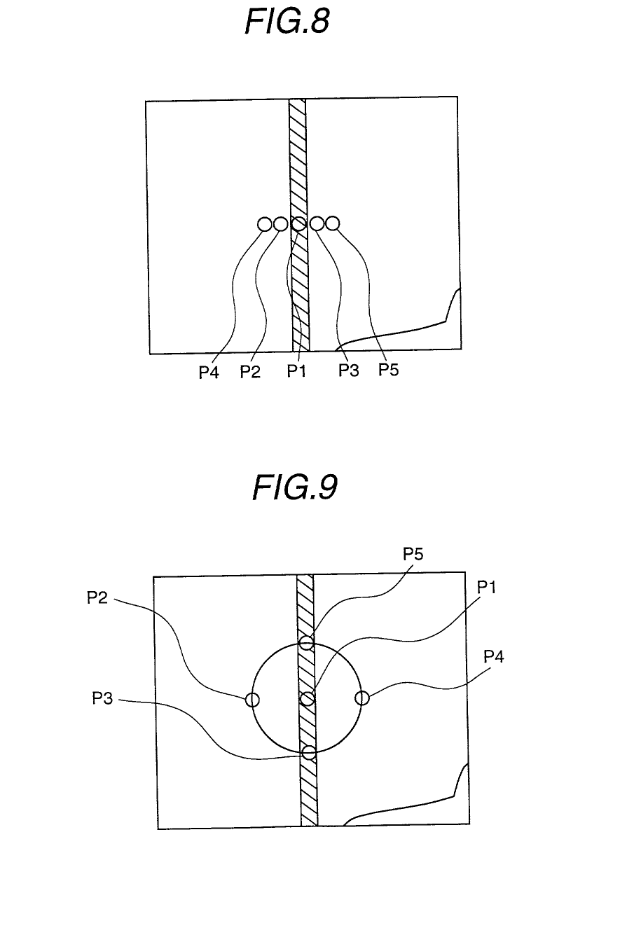

FIG. 8 shows a type in which the analysis points 1 to 5 are arranged on a straight line which goes through the analysis point 1 existing in the grain boundary and the analysis point 2 existing outside of the grain boundary.

In case of this type, the distance L is obtained from the positional information of the analysis points 1 and 2 by the electron microscope control equipment 15, and the positions of the analysis points 3 to 5 are respectively calculated based on the distance L by the electron microscope control equipment 15.

In this case, the analysis points 3 to 5 are disposed respectively apart from +L, −2L, and +2L from the analysis point 1.

Accordingly, the distance between the analysis points next to each other is L.

FIG. 9 shows a type in which the analysis points 2 to 5 are arranged on a circle having analysis point 1 as a central point in the grain boundary and a radius of the distance from the analysis point 1 to the analysis point 2 with the same angles; that is, 90° obtained by dividing 360° by the total number N of the analysis points subtracted by 1.

In case of this type, the distance L is obtained from the positional information of the analysis points 1 and 2 by the electron microscope control equipment 15, and the positions of the analysis points 3 to 5 are respectively calculated based on the distance L.

Relating to the position of the analysis points except 1 and 2, if they are calculated based on the positional information of the analysis points 1 and 2, there is no need to move the sample for all the analysis points to deflect the electron beam and determine the position.

A difference of the composition in nano meter region comes to have a significant meaning recently. Accordingly when the elementary analysis is performed, not only the part requested to be analyzed but also the peripheral plural part thereof needs to be analyzed. However, in such a case, after having respectively set the size of the electron beam by adjusting the irradiation lens current and the irradiation position of the electron beam on the sample namely the analysis position by adjusting the deflecting coil current, the elementary analysis device is switched on, and the elementary analysis signal is measured from 100 to 200 seconds, and this operation is taken place repeatedly only the number of analysis department.

Moreover, precise position of the plural parts to be analyzed and the analysis result corresponding to the position become very important. For example, when a difference of the composition is measured in the connection boundary department having different composition and several points in the neighborhood thereof (the point being 1 nm, 2 nm and 3 nm away from the connection boundary),

After the electron beam is irradiated by a hand control to the analysis point, and the analysis is taken place, an analysis of the next point is performed by a visual inspection. (For example when the magnification is 1000000 times, 1 mm is moved corresponding to 1 nm by the visual inspection of the operator)

However, there is a case to contain an error even if respective distances of analysis points should be equal distance.

According to the embodiment of the present invention, as the other plural analysis points are capable to be located on the basis of a change minute of the deflecting coil current equivalent to the distance of the two analysis points, it becomes possible to be analyzed with an equal distance to the both sides of the connection boundary as a center. Moreover, as the distance of the two analysis points may be measured with the distance of the reference set up, if, for example, the distance of the reference is an actually measured value 1.3 nm, several points are analyzed with a distance of 1.3 nm. After having revised a change minute of the deflecting coil current so that the distance of this reference becomes to be 1.0 nm, plural analysis points are analyzed with 1 nm distance. The connection boundary department may be almost straight, particle state, etc., and when the difference of the composition in the nano meter region controls characteristic of the material, analysis position accuracy becomes very important.

In the above-mentioned example, N becomes 3 or more, and the positions of the analysis points 3 to 5 are calculated based on the positional information of the analysis points 1 and 2; however, N may be 2 or more, and the same step as the step 1 (S1) and step 2 (S2) may be used relating to the analysis points after the analysis point 3, and thereby the positional information and the electron beam size information may be stored with the location identification data in the electron microscope control equipment 14.

In this case, there is no need to calculate the position of the analysis point after analysis point 3, based on the positional information of the analysis points 1 and 2, as in the case that N is 3 or more as explained above.

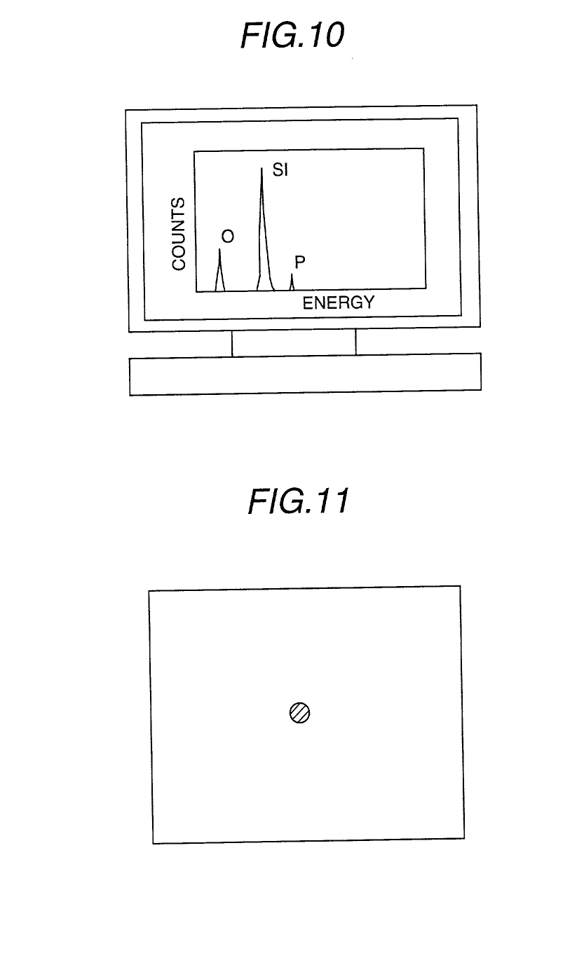

The analysis result of the analysis point may be shown on the display device, and may be stored. FIG. 10 shows an example displaying the analysis result of the analysis point 1.

In this figure, the horizontal scale represents energy, and the vertical scale represents X-ray strength (a counted number).

The data of this figure shows the spectrum of oxygen (O), silicon (Si) and phosphorus (P) contained in the semiconductor sample.

At the same time that an analysis start signal is transmitted to the analysis device in step 8 (S8), the image of the spot size of the electron beam image is taken by an image pickup device 22 automatically, it is shown on an image control display device 23, and is stored. Such a display example is shown in FIG. 11.

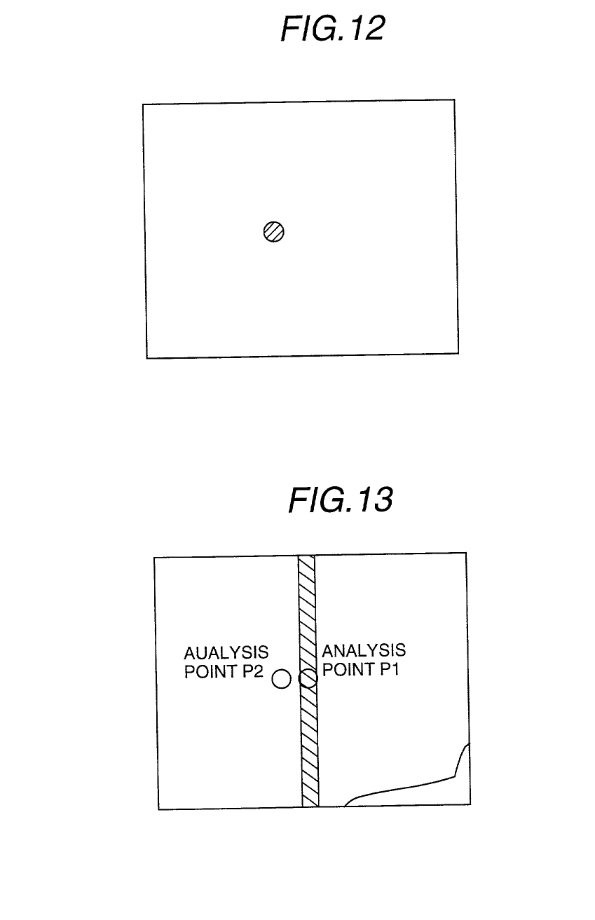

Moreover at the same time the analysis end signal is transmitted to the electron microscope control equipment 15 in step 11 (S11), the image of the spot size of the electron beam is taken by the image pickup device 22 automatically, and is shown on the image control display device 23 and may also be stored. Such a display example is shown in FIG. 12.

In this way, the position difference of the analysis points obtained when and after the elementary analysis is analyzed may be checked by comparing stored spot images.

Moreover, the actual position of the analysis point and the size information of the electron beam and the position identification data thereof (data such as the analysis point 1 or the analysis point 2 may be indicated so as to be overlapped on the electron microscope image of the desired analysis region.

An example is shown by FIG. 13, in which the position, the size information of the electron beam and the identification data are indicated so as to overlap to the image of the desired analysis part, in the analysis points 1 and 2.

Of course there may be a larger number of the analysis points indicated. According to this example, the position relationships of the analysis points in the analysis request region become clear.

In addition to the above, the size information of the electron beam may be displayed relating to the analysis points 1 and 2 by reading out an already stored one and putting it in the image control display device 23, moreover, relating to the analysis point 3 to 5, it is possible to put the position identification information into the image control display device 23 when the position is calculated.

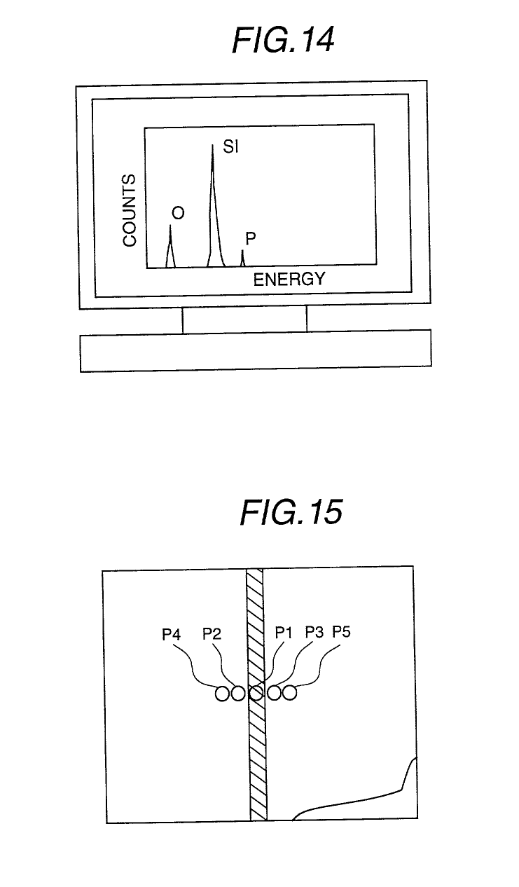

An example of the elementary analysis data of the analysis point 1 is shown in FIG. 10, to a spectrum of phosphorus (P); for example, an energy window is set up for phosphorus (P) as shown in FIG. 14 by the elementary analysis control equipment 17, and then, the position of the analysis points 1 to 5 and the position identification data are displayed so as to overlap on the electron microscope image in the desired analysis region of the image control display device 23, are stored, and the output of a printer 24 is shown in FIG. 15.

However, the example shown in FIG. 15 is an analysis type shown in FIG. 8.

The electron microscope control equipment 14 receives the value of the content of the phosphorus (P) of the analysis points 1-5 through the interface means 21 from the elementary analysis control equipment 17, and transmits it to the image control display device 23.

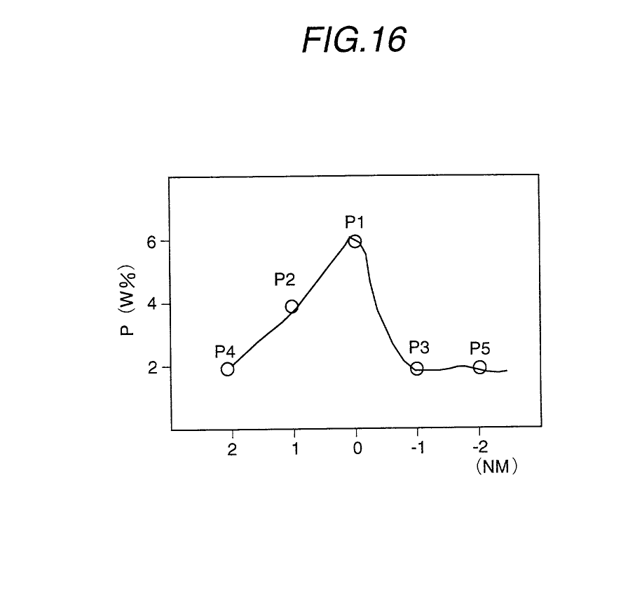

The image control display device 23 makes a graph by several analysis points of the content of phosphorus (P) from distance L of the analysis point (L=1 nm), the content of the phosphorus (P) and identification data of the plural analysis points (analysis point 1 to 5) as shown in FIG. 16, and the graph is output by the printer 24.

In the previously explained embodiment, the X-ray elementary analysis device is used as the elementary analysis device, however the electron beam energy-loss analysis device may also be used.

According to the embodiment of the present invention as mentioned above, the elementary analysis of desired several analysis points is performed automatically and effectively.

Thereby, the operation of an elementary analysis by the electron microscope is simplified, and the desired result is obtained easily in a short time.

Moreover, as a conventional way to summarize the analysis result, development and printing are performed after having input an electron microscope image, points (analysis range) analyzed on the electron microscope image photograph is marked with a seal, and a distribution map is made from the analysis result corresponding to the analyzed points; however in the present invention, such troublesome work as that becomes unnecessary as the graph showing the distribution is received.

According to the present invention, the analysis electron microscope, which is capable performing the elementary analysis of plural analysis points of the sample effectively, is offered.

What is claimed is:

1. An analysis electron microscope comprising a means for generating an electron beam, a means for irradiating a sample with said electron beam, a means for producing an electron microscope image of said sample by magnifying said electron beam transmited through said sample, and an elementary analysis device for elementary-analyzing an irradiated part of said sample by irradiating it with said electron beam, said analysis electron microscope characterized by further comprising
a means for storing positional information of plural analysis points of said sample, wherein
reading out of said stored positional information, setting of positions of said analysis points irradiated by said electron beam on the basis of said positional information read out, and said elementary analysis by said elemental analysis device of said irradiated analysis point are automatically executed with an order determined previously about said plural analysis points.

2. An analysis electron microscope comprising a means for generating an electron beam, a means for irradiating a sample with said electron beam, a means for producing an electron microscope image of said sample by magnifying said electron beam transmitted through said sample, and an elemental analysis device for elementary-analyzing an irradiated part of said sample by irradiating it with said electron beam, said analysis electron microscope characterized by further comprising
a means for storing positional information of plural analysis points of said sample, and size information of said electron beam which should irradiate said analysis point, wherein
reading out of said stored positional information and said size information, setting of positions of said analysis points irradiated by said electron beam on the basis of said positional information and said size information read out, and said elemental analysis by said elemental analysis device of said irradiated analysis point are automatically executed with an order determined previously about said plural analysis points.

3. An analysis electron microscope comprising a means for generating an electron beam, a means for irradiating a sample with said electron beam, a means for producing an electron microscope image of said sample by magnifying said electron beam transmitted through said sample, and an elemental analysis device for elementary-analyzing an irradiated part of said sample by irradiating it with said electron beam, said analysis electron microscope characterized by further comprising
a means for storing positional information of plural analysis points of said sample, and size information of said electron beam which should irradiate said analysis point, wherein
reading out of said stored positional information and said size information, setting of positions of said analysis points irradiated by said electron beam on the basis of said positional information and said size information read out, said elemental analysis by said elemental analysis device of said irradiated analysis point, and storing of results of said elemental analysis are automatically executed with an order determined previously about said plural analysis points.

4. An analysis electron microscope comprising a means for generating an electron beam, a means for irradiating a sample with said electron beam, a means for producing an electron microscope image of said sample by magnifying said electron beam transmitted through said sample, and an elemental analysis device for elementary-analyzing an irradiated part of said sample by irradiating it with said electron beam, said analysis electron microscope characterized in that
plural analysis points not less than three of said sample are constructed to be automatically elemental-analyzed with an order determined previously by using said elemental analysis device, said elementary analysis is performed, after positional information relating to the first and second analysis points of said plural analysis points is stored to a storage device previously, and said position is set automatically based on said stored positional information, and said elementary analysis is performed, after said positional information relating to the remaining one of said analysis points is calculated automatically based on said positional information of said first and second analysis points, and said position of the remaining one of said analysis point is set automatically based on said calculated positional information.

5. An analysis electron microscope comprising a means for generating an electron beam, a means for irradiating a sample with said electron beam, a means for producing an electron microscope image of said sample by magnifying said electron beam transmitted through said sample, and an elemental analysis device for elementary-analyzing an irradiated part of said sample by irradiating it with said electron beam, said analysis electron microscope characterized in that
plural analysis points not less than three of said sample are constructed to be automatically elemental-analyzed by using said elemental analysis device with an order determined previously, said elementary analysis is performed, after positional information relating to first and second analysis points of said plural analysis points is stored to a storage device previously, and said position of said first and second analysis points and size of said electron beam irradiating said first and second analysis points are set automatically based on said stored positional and size information, and said elementary analysis is performed, after said positional information relating to remaining one of said analysis points is calculated automatically based on said positional information of said first and second analysis points, and said position of remaining one of said analysis point based on said calculated positional information and size of said electron beam irradiating said remaining position based on said stored size information are set automatically.

6. An analysis electron microscope comprising a means for generating an electron beam, a means for irradiating a sample with said electron beam, a means for producing an electron microscope image of said sample by magnifying said electron beam transmitted through said sample, and an elementary analysis device for elementary-analyzing an irradiated part of said sample by irradiating it with said electron beam, said analysis electron microscope characterized in that plural analysis points not less than three of said sample are constructed to be automatically elemental-analyzed and to be stored by using said elemental analysis device with an order determined previously, said elementary analysis is performed, after positional information relating to first and second analysis points of said plural analysis points is stored to a storage device previously, and said position of said first and second analysis points and the size of said electron beam irradiating said first and second analysis points are set automatically based on said stored positional and size information, and said elementary analysis is performed, after said positional information relating to the remaining one of said analysis points is calculated automatically based on said positional information of said first and second analysis points, and said position of the remaining one of said analysis point based on said calculated positional information and size of said electron beam irradiating said position of remaining one of said analysis point based on said stored size information are set automatically.

7. An analysis electron microscope as defined in claims 4 to 6, wherein
said plural analysis point are positioned on a straight line connecting said first and second analysis points.

8. An analysis electron microscope as defined in claim 7, wherein
the distance between one of said plural analysis points and other of plural analysis points next thereto is equal to that between said first and seconds analysis points.

9. An analysis electron microscope as defined in claims 4 to 6, wherein
said analysis point except said first analysis point is on a circle having a central point disposed on said first analysis point and having a radius which is equal to a distance between said first and the second analysis points.

10. An analysis electron microscope as defined in claim 8, wherein
the distances of said analysis points on said circle are disposed equally each other.

11. An analysis electron microscope as defined in claims 4 to 7, wherein
said first analysis point is disposed on a requested central part to be analyzed relating to said samples.

12. An analysis electron microscope as defined in claims 1 to 11, said analysis electron microscope further comprising
a means for taking said electron microscope image, a means for storing said electron microscope image, and a means for displaying said electron microscope image, wherein
said means for taking said electron microscope image is operated automatically at the start and end of said analysis by said elementary analysis apparatus.

13. An analysis electron microscope as defined in claim 12, wherein
said positions of said plural analysis points, identification data of said position, and said size information of said electron beam irradiating the position are displayed on said display means with said electron microscope image.

14. An analysis electron microscope as defined in claim 13, wherein
said elementary analysis result of said every plural analysis points by said elementary analysis device are displayed with said analysis position data and are stored every plural analysis points so as to be understood said distance between said analysis points.

15. An analysis electron microscope as defined in claim 13, wherein
said elementary analysis result relates to an elemental content of said sample.
